(19) United States
(12) Patent Application Publication
(10) Pub. No.: US 2011/0167477 A1
(43) Pub. Date: Jul. 7, 2011

(54) METHOD AND APPARATUS FOR PROVIDING CONTROLLED ACCESS TO A COMPUTER SYSTEM/FACILITY RESOURCE FOR REMOTE EQUIPMENT MONITORING AND DIAGNOSTICS

(76) Inventors: NICOLA PICCIRILLO, Schenectady, NY (US); GANESH KUMAR, Bangalore (IN)

(21) Appl. No.: 12/683,799

(22) Filed: Jan. 7, 2010

(51) Int. Cl. H04L 9/32

(52) U.S. Cl. 726/4

(57) ABSTRACT

A hardware-software user connectivity control method and apparatus which provides a secure controlled access arrangement that enables only authorized users to obtain access to stored proprietary information and processing tools/applications on a computer-implemented global monitoring system/network (GMS) used to monitor and diagnose steam turbine power generator equipment and plants. An authentication challenging application (ACA) in the GMS sends a challenge sequence of code/numbers via a non-secure communications link/channel to an authentication response application (ARA) resident on a user/customer computer system. The ARA must respond via the same communications link/channel with an expected response code/number sequence to enable the user's access to the GMS otherwise the communications link/session is terminated. The ARA may optionally be stored on a portable flash memory dongle gaining direct access to the GMS locally. Additionally, a proprietary port connector device is needed when making a direct access connection locally via the GMS facility communications port.

The subject matter disclosed herein relates generally to controlling access to a computer system/network-implemented equipment monitoring and diagnostic facility. More specifically, technology disclosed herein relates to a method and apparatus for providing secure user access and controlled connectivity to a globally accessible proprietary online computerized information storage and management facility used to monitor and diagnose steam turbine power generator equipment. In particular, the technology disclosed herein relates to a hardware-software user interface connectivity method and apparatus for providing a controlled and secure access environment that enables only authorized users to obtain direct and/or remote access to proprietary data/information and processes of an online computer system/facility resource.

### BACKGROUND

During the use and operation of steam turbine power generating equipment, the operating condition of numerous pieces of equipment and various operational processes must be monitored continually so as to obtain early indications of equipment malfunctions or to predict potential equipment failures well in advance so that appropriate corrective measures may be implemented in sufficient time to preclude possible injury to personnel and financial loss due to equipment down time. Conventionally, processes such as the generation of electricity in a steam turbine power generator plant employ typically hundreds of sensors throughout the plant to provide real-time status of equipment operational parameters. The turbine equipment is often monitored remotely and the acquired sensor data/information sent across either dedicated or public communications lines to a specialized equipment monitoring/diagnostics facility that maintains a proprietary computer system/network specifically for providing such services. Moreover, the monitoring/diagnostics facility may provide such services to multiple clients for a multitude of plants geographically situated in diverse locations across the globe. In addition, real time access to the monitored equipment information as well as some degree of control over the diagnostics process and analysis of the acquired sensor data must be made available and accessible both locally at the monitoring/diagnostics computer facility as well as remotely from a diverse variety of global locations where various plants and engineers may be situated.

For example, continuous onsite observation and interpretation of steam turbine equipment sensor data may be needed by operators at a specific power generating plant so that any appropriate action, which might be deemed desirable from an economic or safety consideration, can be immediately instigated. Additionally, plant engineers and repair technicians often need access to various software tools/applications, historical operational fleet data and proprietary knowledge base information which may only be available from the remote monitoring/diagnostics computer facility. In addition, it is often desirable to be able to perform such diagnostics, tuning or repairs from a location that is remote from the specific plant/equipment and/or remote from the monitoring/diagnostics computer facility. However, it is highly desirable that any local or remote access to the monitoring/diagnostic computer facility/network and as well as the proprietary applications and data contained therein must be made secure and accessible only to authorized persons or entities. Moreover, it is also important that power generating facilities and electric utilities become and remain compliant with contemporary NERC-CIP (North American Electric Reliability Council Critical Infrastructure Protection) standards regarding cyber security for critical infrastructure protection concerning access to power plant/utilities computer and digital information systems for implementing adequate protection of power plants and electric utilities against any potential electronic threats. For example, among other things, these NERC-CIP standards require that such facilities keep strict track of who is requesting access to data/information, what data/information is being requested and when such access or requests are being made.

In this regard, it is highly desirable to have a controlled and secure access environment that enables only authorized users to obtain access to the proprietary data and operations information provided by the equipment monitoring/diagnostics computer facility. In addition, any such security system/arrangement should also provide some capability for keeping accurate records of who, what, when and how often access attempts are made to the computer facility in accordance with appropriate NERC-CIP standards.

### BRIEF DESCRIPTION

A specific hardware-software user connectivity arrangement/environment and control process is described herein. For the particular hardware-software user connectivity management arrangement contemplated, a non-limiting illustrative exemplary implementation is disclosed that provides controlled access to proprietary computer equipment and/or facilities used for remote monitoring and diagnostics of steam turbine power generating plants/equipment. In particular, the non-limiting example hardware-software implementation described herein provides a user connectivity arrangement/environment and control process that enables both local and remote access to a specialized monitoring/diagnostic computer facility/network and the proprietary applications and data contained therein to be made secure and effectively transparent.

Although the illustrative non-limiting example implementation of the secure hardware-software user-interface connectivity arrangement described herein is generally applicable toward providing security and access control for a multitude of different types of digital computer systems and networks, the particular non-limiting implementation disclosed herein is presented by way of example for use in a computer/server implemented system configured for providing ongoing real-time monitoring services and performing expert system-based diagnostics of steam turbine generator power plant equipment and operations, and for providing secure controlled access to authorized customers/clients requiring such services.

Another aspect of the non-limiting illustrative example implementation disclosed herein includes equipping the GMS facility hardware interface ports with proprietary port connectors/plugs and requiring a matching connector/plug device to be used on all user computer/workstation equipment or user USB dongle devices for making local direct communications/connections to the GMS facility computer equipment.

### BRIEF DESCRIPTION OF THE DRAWINGS

The block and flow diagrams in the figures below do not necessarily represent an actual physical arrangement of the example system, but are primarily intended to illustrate major structural components in convenient functional groupings so that the non-limiting illustrative exemplary implementation presented herein may be more readily understood. The above described features and other aspects and advantages will be better and more completely understood by referring to the following detailed description of exemplary non-limiting illustrative implementations in conjunction with the drawings of which:

FIG. 1 is block diagram illustrating a general overview of a proprietary machine equipment/process global monitoring system (GMS) on which the disclosed nonlimiting illustrative example method and apparatus for providing access control and secure connectivity may be implemented;

FIG. 2 is a block diagram illustrating a nonlimiting example implementation of an arrangement for providing access control and secure connectivity to a proprietary GMS computer facility for one or more remote users/clients;

FIG. 3 is a block diagram illustrating a nonlimiting example implementation of an arrangement for providing access control and secure connectivity to a proprietary GMS computer facility for one or more local users; and

FIG. 4 is a process flow diagram illustrating a nonlimiting example implementation of a computer-implemented method for providing access control and secure connectivity to a proprietary GMS computer facility.

### DETAILED DESCRIPTION

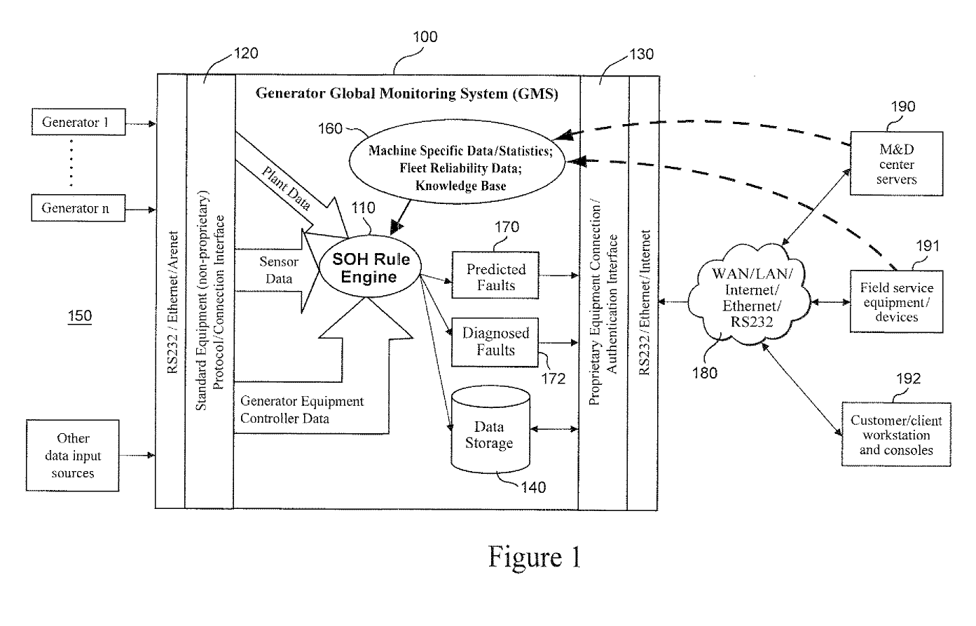

In FIG. 1, a high level block diagram of a Generator Global Monitoring System (GMS) facility is generally illustrated at numeral 100. This non-limiting example GMS may comprise one or a plurality of digital computers or processors/servers that together form either a centrally located or a distributed system/network for providing monitoring and diagnostic services for owners and operators of steam turbine power generating plants and equipment. The Generator Global Monitoring System (GMS) 100 may also include, among other things, one or more information/data processing engines such as an equipment diagnosis State-of-Health (SOH) Rule engine 110, conventional RS232/Ethernet/Arenet/Internet communications interface equipment 120, authorized proprietary user interface equipment 130, a mass data storage facility/equipment 140 for storing, among other things, acquired data from monitored generator equipment and other sources 150, and specific machine/equipment operational history data/statistics, proprietary knowledge-base information including fleet reliability data 160, as well as various proprietary analysis/diagnostic software application tools for predicting and diagnosing equipment faults/failures 170, 172. Preferably, the GMS 100 is made accessible to one or more user/customer devices at both a direct-connect interface local to the GMS hardware and from multiple remote locations via, for example, the Internet or other conventional Ethernet/RS232/WAN/LAN 180. In this example GMS arrangement, machine specific operational data, fleet reliability data/statistics, and other proprietary knowledge-base information 160 is provided and may be accessed, for example, via one or more remotely located monitoring and diagnostic (M&D) center servers 190 and/or via various in-the-field service equipment 191—such as portable laptop computers, mobile devices or other test equipment typically used by service technicians. Machine specific data/statistics 160 also may include configurable parameters that are used to tune and set baselines for the rules used by the SOH rule engine 110. In addition, such information/data may be further supplemented or accessed by operator consoles and workstations 192 situated at various client/customer plants.

Although the GMS may provide remote monitoring and diagnostic services directly for one or more clients/customers that are operating turbine power generators and associated equipment, much of the monitoring and at least some diagnostics may be actually performed by one or more wide area networked computer/server centers located remote from the GMS. These monitoring and diagnostic (M&D) centers 190 typically provide local services for specific plants/equipment. In at least one non-limiting example implementation, conventional computer application programs known as knowledge-based expert systems are used for analyzing the sensor and other data acquired from the equipment. Conventionally, such diagnostics programs are typically “expert system-based” systems containing a multitude of situational rules generated as a result of interviewing one or more diagnostic experts relative to a specific piece of equipment. As more and more information is acquired about specific plants or equipment over a period of time, the associated diagnostics program may be easily updated and customized by adding, deleting, or modifying specific diagnostic rules.

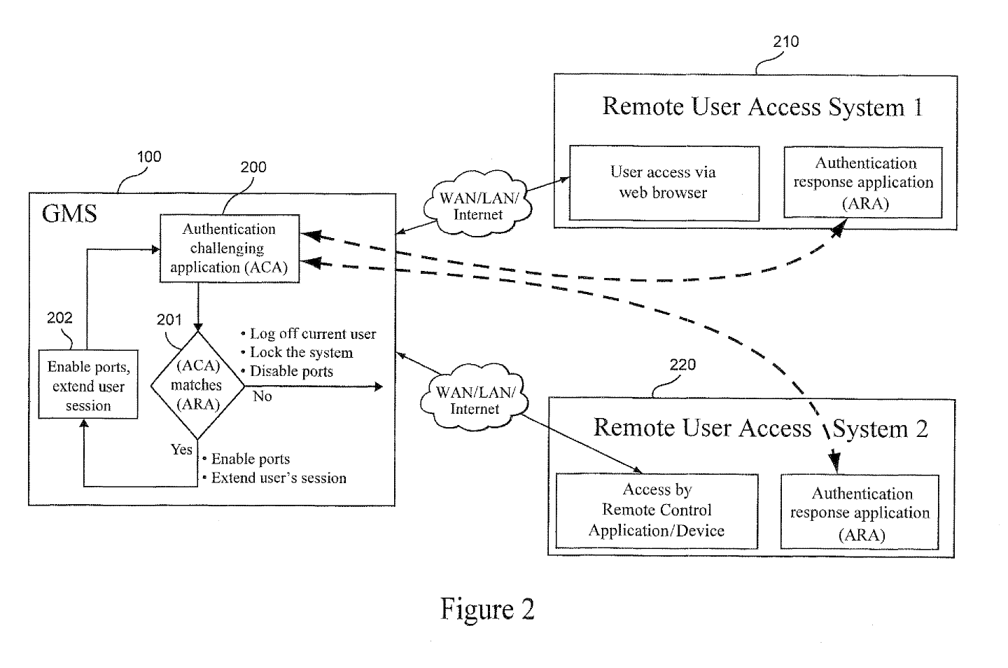

In FIG. 2, a functional block diagram shows a general overview of a nonlimiting illustrative example implementation of an arrangement for providing access control and secure connectivity to a proprietary GMS computer system/network which is accessible to one or more remote users/customers via conventional wired and wireless networked communications links such as a WAN/LAN, the Internet or the like. In this nonlimiting illustrative example implementation, the GMS 100 is provided with a proprietary authentication challenging application (ACA) 200 which runs as a background application on a GMS computer/server. Similarly, one or more authorized users/customers are provided with a proprietary authentication response application (ARA) which is situated on a user's access system/computer or device and may also run as a background application so as to effectively be transparent to the user. For example, in this nonlimiting illustrative implementation, one remote user access computer system/device 210 is contemplated as a computer terminal/workstation having a web browser with an embedded ARA software component and another remote user access computer system/device 220 is contemplated as a computerized machine/equipment remote controller device having an embedded ARA software component. During communication between the GMS and an external system/device having the ARA software component, specific information such as a digital signature or other numerical code is exchanged between the ARA and the ACA in an ongoing, repetitive and timely basis in a manner that allows the ACA to continually verify that the connected external system/device or entity is authentic and that communication with it is authorized. One of ordinary skill in the art would appreciate that the ACA and ARA software components are also contemplated as being crafted so as to operate and communicate using one or more of the conventional communication protocols such as Windows™ network protocol, conventional TCP/IP based protocols and/or other known proprietary remote control software protocols such as PCAnywhere™, NetMeeting™, etc.

Referring to GMS functional block diagram 100 of FIG. 2, the ACA software component 200 is integrated into the communications interface functioning of the GMS and is able to recognize when an attempt or request is being made from an external system/device 210 or 220 to connect to the GMS. Before a communications session is permitted to proceed, the ACA first verifies that the received communication originates from an authorized source or IP address and that each further received digital communication also originates from the same original IP address/source. For example, the GMS may maintain a database having a list of authorized users including IP addresses, access system names, and other ID information, and the ACA can be set up to cross check the sender's IP address or system name against the database and/or to require digital signature information from the sender for each received digital communication or at least once per communication session. Once the access requesting external system/device is verified as an authorized user access system and communications access the GMS has been allowed, the ACA then begins to periodically challenge the external remote user system/device by sending a challenge query to the ARA in the system/device. This challenge query may take a variety of forms based on one or more of the known conventional challenge-response type security schemes or a particular proprietary algorithm. For example, the challenge may consist of a specific code number or sequence of numbers/codes which is either predetermined or computed based on some predetermined algorithm used by the ACA and ARA software components within each machine. In response to the challenge sent by the ACA, the ARA in the remote system/device must in turn respond in a timely fashion with a specific numerical response code/sequence. Once the response is received by the GMS, the ACA then assesses whether the response corresponds to an expected response sequence/code based on the predetermined algorithm or, alternatively, use the received response code/number to check a GMS maintained database of authorized users.

For example, as illustrated by the nonlimiting general example illustrated in block 100 of FIG. 2, the ACA component 200 sends a challenge query to the ARA component in a remote user access system (210 or 220) and receives a response back from the ARA (indicated by dotted line connecting ACA and ARA blocks). Next, as indicated in diamond 201, the ACA checks to determine whether the response received from the ARA match an expected response. If the received response fails to match the expected response then the remote user system can be logged-off and/or the particular communications port disabled or further access to the GMS otherwise blocked. On the other hand, if the received is determined to match the expected response, then the communications port remains enabled and the communications session is allowed to continue for at least some additional predetermined period of time, as indicated at block 202. After a predetermined period, the ACA again sends a challenge inquiry to the connected user computer/system and the access control process continues until the remote user computer/system voluntarily ends the session or the session is otherwise terminated by the ACA. Although not explicitly illustrated by the FIGURES herein, a preferred implementation of the GMS would also include appropriate hardware and software to keep track of all system access requests and to conform to the applicable NERC-CIP standards regarding cyber security for critical infrastructure protection. For example, although not explicitly depicted in the FIGURES, access to the GMS may be implemented through an FTP server situated between two firewalls. Moreover, one skilled in the art would recognize that conventional computer hardware and software techniques for conforming to the NERC-CIP standards and for implementing such record keeping tasks are well known and readily implemented by the conventional computer hardware used within the GMS.

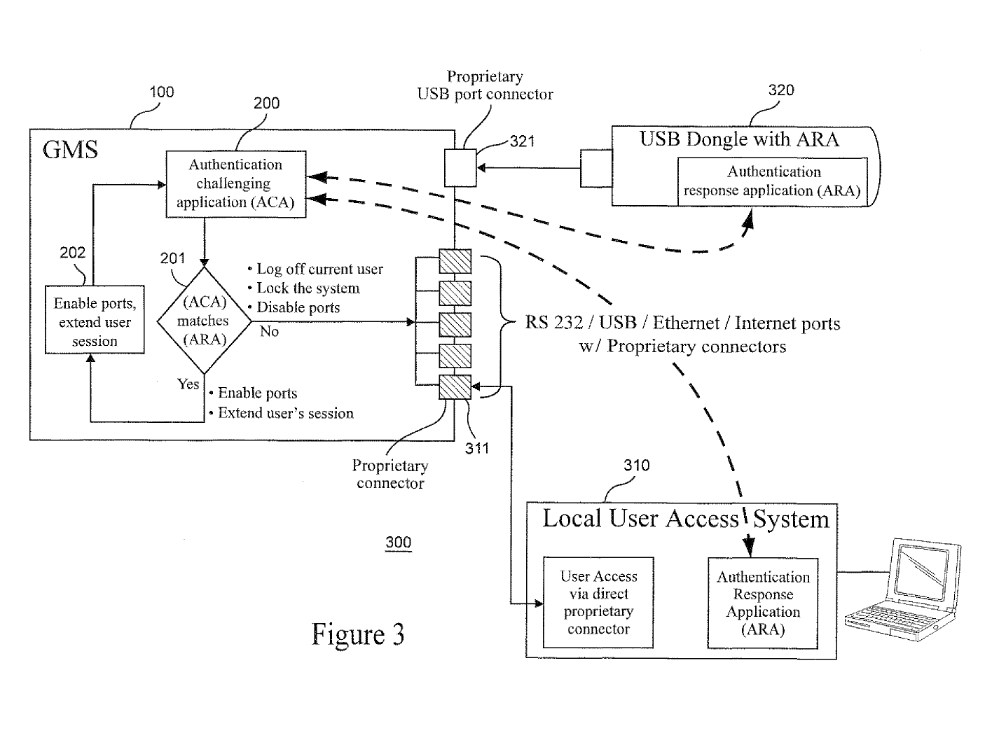

Referring next to FIG. 3, a functional block diagram shows a general overview of a nonlimiting illustrative example implementation of another aspect of the contemplated arrangement for providing control and secure connectivity for local user intending to use the physical ports on the GMS for direct access to a proprietary computer system/network which uses the same ACA and ARA software components as discussed above in reference to FIG. 2. In this aspect, the GMS computer system/network is provided with an access control and security for one or more local user systems/devices. As indicated in FIG. 3, a user access system/computer may be a local computer/laptop or workstation 310 which may or may not include the appropriate ARA software component. If the ARA software component is not incorporated or resident within the local user system 310, an alternative arrangement may be implemented, for example, wherein a proprietary USB dongle device 320 which houses a flash memory can store the ARA software and a separate processor for communicating with the ACA for enabling a predetermined I/O port. In addition, the GMS communications hardware interface I/O ports are preferably customized using proprietary non-standard construction or components for the USB port connector 321. Likewise, the local RS-232/Ethernet/Internet hardware interface input/output port connections may also be customized using non-standard proprietary connectors 311. In this example, the ACA component in the GMS will periodically probe ARA component in the USB dongle 320 to see if a returned code matches and corresponds to a particular pre-assigned user/system or laptop/workstation which is locally connected to the GMS at a particular predetermined physical port. If the ARA component in the USB dongle 320 fails to respond accurately to the ACA component 200 in the GMS, then the particular I/O port (or ports) that is used to connect a user system (Laptop/workstation) will be disabled and all further communications on that port prohibited until re-enabled manually by an authorized systems operator of the GMS. In this manner, the disclosed security arrangement serves to preclude any further threats or compromises to security from occurring via that same port or connection.

Although a particular preferred structure for such an non-standard proprietary port connector 311 and/or 312 is not explicitly disclosed or specified herein, one of ordinary skill in the art would recognize that such non-standard connector devices could be readily implemented employing a wide variety of different designs and that the choice of any one particular design over another would not affect either the operation or the implementation of the disclosed method and arrangement for providing a controlled and secure access to a proprietary computer system/facility. Moreover, virtually any such matching/mating non-standard proprietary connector/plug arrangement could be used so long as it serves its function as an electrical connector and is fabricated as a non-standard piece of equipment whose source and distribution may be securely controlled. Accordingly, applying this aspect of the disclosed method and arrangement for providing a controlled and secure access to a proprietary computer system/facility, it becomes necessary to first realize a physical connection to the GMS via use of an appropriate proprietary port connector device in addition to having the appropriate ARA software component on the user access system/device. Consequently, gaining local access to the GMS computer/facilities will be nearly impossible, or at least very difficult, unless the local user access system/device is first outfitted with the necessary mating proprietary port interface connector hardware. Requiring use of non-standard local port interface hardware security equipment thus provides an additional level of access control and security on top of the disclosed ACA-ARA software security component at least for the reason that the availability and distribution of such non-standard port interface security connectors may be carefully supervised and controlled.

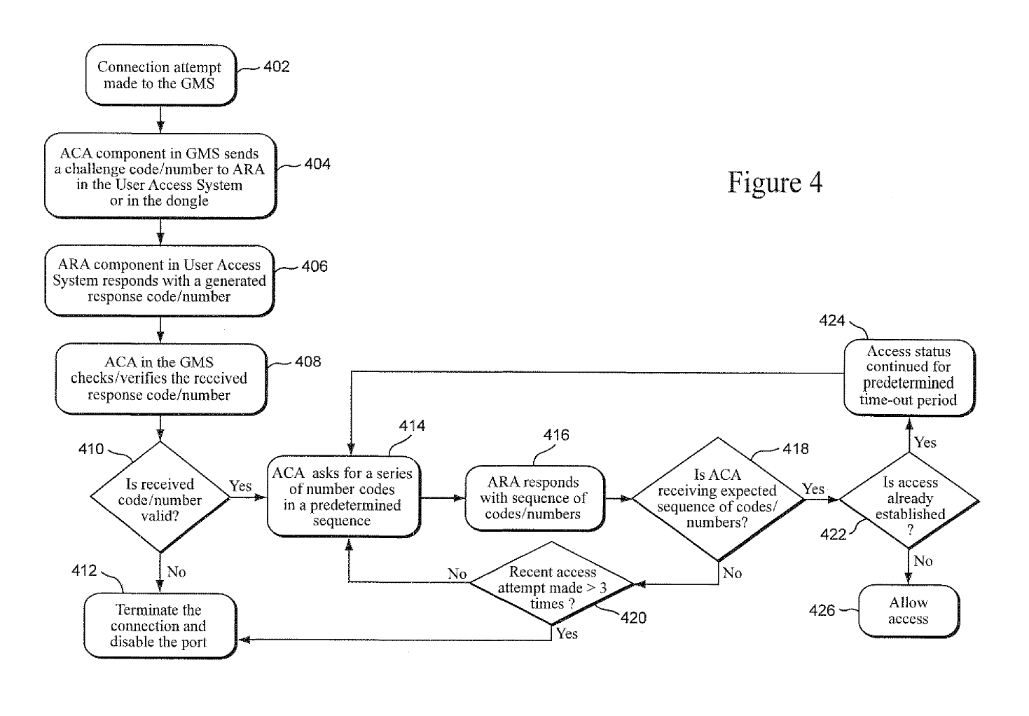

Referring now to FIG. 4, a process flow diagram 400 illustrates a nonlimiting example implementation of a computer-implemented method for providing access control and secure connectivity to a proprietary GMS computer system/network for one or more users. One of ordinary skill in the art would realize that a variety of computer program instructions and program routine steps may be employed to achieve the desired function and results as the exemplary computer program processes described herein, and that an implementation of the computer program method described herein is not intended as being limited to the specific example of FIG. 4. In addition, although the nonlimiting example computer application processes described below are of particular use in providing a controlled and secure access environment for enabling only authorized users to obtain access to a proprietary GMS facility, one of ordinary skill in the art would appreciate that it could be readily modified without undue experimentation to provide controlled access and security for other types of digital computing facilities/systems.

Beginning with block 402, the authentication challenging application (ACA) software component resident on the GMS computer system/network recognizes that a request or an attempt to connect and access the GMS is being made from an unknown external system or user. For example, a user/customer computer system containing the software authentication response application (ARA) may be making an attempt to connect and log-on to the GMS facility computer system/network via, for example, a conventional WAN/LAN, Internet/Ethernet/RS-232 communications lines or a local RS-232/Ethernet/USB port connection. Next, in block 404, upon receiving such a request for access, the ACA software component in the GMS facility computer system/network is activated to send to the requesting user/customer computer information consisting of a predetermined specific access “challenge” and then to wait to receive a specific appropriate response from the same requesting user/customer computer. Although in this particular non-limiting example, the predetermined access challenge is disclosed as a specific predetermined digital code/number, the predetermined challenge and response information may be any form or type of encrypted or non-encrypted digital information and a particular implementation of the method disclosed herein is not intended to be limited to using any specific type of information or data as form of access challenge or response.

Next, in block 406, the ARA software component in the user/customer computer requesting access generates and sends a specific “response” code/number back to the GMS in response. The ARA may use a specific predetermined code/number or a particular predetermined algorithm or proprietary algorithm to generate the specific response code/number, so long as the ACA software component in the GMS is able to independently determine or duplicate the same specific response code for that particular user/customer. In block 408, after receiving a response code/number from the user/customer computer requesting access, the ACA software component in the GMS checks or verifies that the received code/number is correct and corresponds to a response code/number expected to be received from that particular user/customer. Next, as shown in diamond 410, if the received code/number is not valid, the ACA disables the communications port and terminates the connection/communication session with the access requesting party/computer as indicated in block 412. Alternatively, if the received code/number is verified as being valid, the ACA sends a second challenge message to the ARA which requires a particular second response by the ARA consisting of a series of codes/numbers which, as indicated in block 414, is preferably a predetermined sequence of codes/numbers that are known or verifiable by the ACA.

Next, as indicated in block 416, the ARA of the computer requesting access preferably responds with a sequence of code/numbers and then, as indicated in diamond 418, the ACA in the GMS checks to verify that the received sequence corresponds to a predetermined expected sequence. If the response or received sequence of code/numbers from the ARA was incorrect or not the expected response sequence, the ACA then determines whether any recent unsuccessful access attempts from the same user/computer have been made. As indicated in diamond 420, if less than three recent unsuccessful access attempts have been made by a particular user/computer, the ACA again requests the ARA in that computer to respond by sending a the appropriate series of codes/numbers. On the other hand, if more than three recent unsuccessful access attempts have been made by a particular user/computer, the ACA disables the communications port and terminates the connection/communication session with the access requesting party/computer as indicated in block 412.

Alternatively, in diamond 418, if the received sequence of code/numbers from the ARA was verifiable by the ACA as being the correct and expected sequence then, as indicated in diamond 422, the ACA determines whether the current communication with that particular user/computer is a new uninitiated communication session or part of an ongoing previously established communication session. If the ACA determines that the current communication is a new uninitiated communication session, it then proceeds to allow access and initiate the session with the requesting user/computer, as indicated in block 426. If the ACA determines that the current communication is part of a previously established ongoing communication session, it allows the session to continue for a random or predetermined time-out period, as indicated in block 424, before again sending a further request to the ARA of the connected computer to ask it to respond again by sending a another series of codes/numbers, as indicated by block 414. The ACA continues to interrogate the ARA software component of a connected user/customer computer in this fashion at the end of every time-out period until the session is terminated by the user/customer computer or the session is terminated by receiving three or more incorrect code/number sequences after a further response request as shown in blocks 420 and 412.

As described above, an implementation of the method and apparatus disclosed herein may be in the form of computer-implemented processes and apparatuses for practicing those processes. An implementation may also be practiced or embodied in the form of computer program code containing instructions embodied in tangible media, such as floppy diskettes, CD ROMs, hard drives, or any other computer-readable storage medium, wherein when the computer program code is read and executed by a computer, the computer becomes an apparatus for practicing the disclosed process or method. An implementation may also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein when the computer program code is read and/or executed by a computer, the computer becomes an apparatus for practicing the disclosed process or method. When implemented on a general-purpose programmable microprocessor or computer, the computer program code configures the programmable microprocessor or computer to create specific logic circuits (i.e., programmed logic circuitry).

While disclosed method and apparatus is described with reference to one or more exemplary embodiments, it will be understood by those skilled in the art that various changes may be made and equivalence may be substituted for elements thereof without departing from the scope of the claims. In addition, many modifications may be made to the teachings herein to adapt to a particular situation without departing from the scope thereof. Therefore, it is intended that the claims not be limited to the specific embodiments disclosed, but rather include all embodiments falling within the scope of the intended claims. Moreover, the use of the terms first, second, etc. does not denote any order of importance, but rather such terms are used solely to distinguish one claim element from another.

This written description uses various examples to disclose exemplary implementations of the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A method for providing controlled and secure access to a computer-implemented equipment monitoring system, comprising:
issuing a first challenge message to an entity requesting communications access to the computer-implemented equipment monitoring system;
receiving a first response from the entity requesting access and checking the first response against a predetermined list of codes/numbers corresponding to authorized users;
issuing a second challenge message to the entity requesting access if said first response comprises a code/number which corresponds to an authorized user, and disallowing access to the computer-implemented equipment monitoring system by said entity if said first response does not comprise a code/number corresponding to an authorized user;
receiving a second response from the entity requesting access in response to the second challenge message and granting communications access to said entity if the second response comprises a predetermined sequence of codes/numbers, and resending said second challenge message to the entity requesting access if the second response does not match said predetermined sequence of codes/numbers, wherein said second challenge message is resent if the second response does not match the predetermined sequence of codes/numbers and communications with the entity requesting access is terminated if a received response does not match the predetermined sequence of codes/numbers after a predetermined number of successive occurrences of receiving a mismatching response;
periodically issuing a further challenge message to an entity granted communications access; and
receiving a further response from said entity granted access in response to said further challenge message and granting continued communications access to said entity if the further response comprises a predetermined sequence of codes/numbers, wherein said further challenge message is resent if the further response does not match the predetermined sequence of codes/numbers and communications with the entity granted access is terminated if a received response does not match the predetermined sequence of codes/numbers after a predetermined number of successive occurrences of receiving a mismatching response.

2. The method of claim 1 wherein said first challenge message comprises a predetermined code/number.

3. The method of claim 1 wherein an entity granted communications access is issued a further challenge message at least once every predetermined period of real time.

4. An apparatus for providing a secure user interface and connectivity arrangement for controlling access to an equipment monitoring and diagnostic system/network, comprising:
first challenge message programmed logic circuitry configured to issue a first challenge message to an entity requesting communications access to the equipment monitoring and diagnostic system/network;
first response programmed logic circuitry configured to receive a first response from the entity requesting access and check the first response against a predetermined list of codes/numbers corresponding to authorized users;
second challenge message programmed logic circuitry configured to issue a second challenge message to the entity requesting access if said first response comprises a code/number which corresponds to an authorized user, and to disallow access to the computer-implemented equipment monitoring system by said entity if said first response does not comprise a code/number corresponding to an authorized user;
second response programmed logic circuitry configured to receive a second response from the entity requesting access in response to the second challenge message and to grant communications access to said entity if the second response comprises a predetermined sequence of codes/numbers, and to resend said second challenge message to the entity requesting access if the second response does not match said predetermined sequence of codes/numbers, wherein said second challenge message is resent if the second response does not match the predetermined sequence of codes/numbers and communications with the entity requesting access is terminated if a received response does not match the predetermined sequence of codes/numbers after a predetermined number of successive occurrences of receiving a mismatching response;
further challenge message programmed logic circuitry configured to periodically issue a further challenge message to an entity granted communications access; and
further response programmed logic circuitry configured to receive a further response from said entity granted access in response to said further challenge message and to grant continued communications access to said entity if the further response comprises a predetermined sequence of codes/numbers, wherein said further challenge message is resent if the further response does not match the predetermined sequence of codes/numbers and communications with the entity granted access is terminated if a received response does not match the predetermined sequence of codes/numbers after a predetermined number of successive occurrences of receiving a mismatching response.

5. The apparatus of claim 4 wherein said first challenge message comprises a predetermined code/number.

6. The apparatus of claim 4 wherein an entity granted communications access is issued a further challenge message at least once every predetermined period of real time.

7. In a computerized equipment monitoring and diagnostic system having a user communications interface for providing security and controlling user access, said communications interface comprising:
challenge message programmed logic circuitry configured to issue a challenge message comprising predetermined digital information to a user device requesting access to the system;
response evaluation programmed logic circuitry configured to check digital information in a response received from said user device against a predetermined database of digital information corresponding to authorized users, and to grant communications access to said user device if the digital information in the received response corresponds to an authorized user; and
periodic challenge programmed logic circuitry configured to periodically issue a further challenge message to said user device, and to determine whether information received from said user device in response to said further challenge message conforms to a predetermined expected response, wherein continued communications access is granted to said user device for at least a predetermined interval of real time only if the response received from said user device matches the predetermined expected response.

8. A communications interface according to claim 7 wherein the challenge message comprises a predetermined digital code or number.

9. A communications interface according to claim 7 wherein a user device granted communications access is issued a further challenge message at least once every predetermined period of real time.

10. A communications interface according to claim 7 further comprising a hardware communications I/O port connector having non-standard male and female connector portions.

11. A computer-implemented method of providing a secure user interface and access control arrangement for an equipment monitoring system, the equipment monitoring system comprising one or more digital computers or processors/servers that together form a system/network for providing monitoring and diagnostic services of industrial equipment or processes over one or more conventional communications networks, comprising:
executing an authentication challenging application (ACA) on at least one computer of said equipment monitoring system; and
executing an authentication response application (ARA) on a user device/computer for communicating with said equipment monitoring system over a communications network;
wherein the ACA and the ARA communicate digitally via a hardwired electrical connection or over a conventional digital communications network, and wherein the ACA issues one or more challenge messages to the ARA and responses provided by the ARA are evaluated by the ACA to verify that the user device/computer is authorized to continue to communicate with the equipment monitoring system.
